(19) United States
(12) Patent Application Publication
(10) Pub. No.: US 2016/0133134 A1
(43) Pub. Date: May 12, 2016

(54) PARKING SPOT ALLOCATION

(71) Applicant: EBAYINC., San Jose, CA (US)

(72) Inventors: Michael Charles Todasco, Santa Clara, CA (US); Anand Lakshmanan, Sunnyvale, CA (US); Leslie Marie Moser, Boston, MA (US)

(21) Appl. No.: 14/538,603

(22) Filed: Nov. 11, 2014

(51) Int. Cl. G08G 1/14; G06Q 30/02; G07B 15/02

(52) U.S. Cl. CPC G08G 1/14; G07B 15/02; G06Q 30/0255

(57) ABSTRACT

Methods and systems for allocating a parking spot to a user are described. When a user enters a parking structure, the user's device is detected by a beacon. The beacon identifies the user, and passes the user's identification and location to a service provider. In some embodiments, the service provider assigns a parking spot to the user based on a user profile associated with the user identification and location. In other embodiments, the service provider transmits the user identification and/or profile information to a merchant. The merchant can then submit parking spot offers for different parking spots at different prices with different incentives.

### BACKGROUND

1. Field of the Invention

The present invention generally relates to assigning parking spots to vehicles, and more particularly to assigning parking spots to vehicles based on a user profile.

2. Related Art

Commercial environments typically include parking lots to allow customers, visitors, and employees to park their vehicles. Often, individuals driving a vehicle have to search for a parking spot in a parking lot or structure. Looking for a parking space wastes time, contributes to traffic congestion, creates frustration, and generates pollution. When convenient parking for a store or shopping district is unavailable or unpredictable, shoppers are discouraged from going out. Thus, improved methods and systems for parking vehicles are needed.

### BRIEF DESCRIPTION OF THE FIGURES

FIG. 1 is a block diagram illustrating a system for allocating a parking spot to a user according to an embodiment of the present disclosure;

FIG. 2 is a block diagram illustrating a service provider server according to an embodiment of the present disclosure;

FIG. 3 is a flowchart showing a method for allocating a parking spot to a user according to an embodiment of the present disclosure; and

FIG. 4 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods of allocating parking spots or spaces to a user. A vehicle enters a parking structure, and a user device is detected by a beacon positioned at an entry point of the parking structure. The beacon passes user device details, such as a user identifier, and location information to a service provider. In various embodiments, the service provider assigns an appropriate parking spot to the user based on a user profile associated with the user ID and the location. For example, the user ID may indicate that the user is an elderly or handicapped person that frequently visits Store X so the service provider assigns a parking spot close to the entrance of Store X. The service provider transmits the assigned parking spot to the beacon, and the beacon passes it along to the user device, which displays the assigned parking spot to the user. In some embodiments, the service provider provides audio instructions to the parking spot. Beacons at the assigned parking spot may detect that an unauthorized user is entering the spot and notify the unauthorized user accordingly, such as a visual (e.g., red light) or sound (e.g., alarm or audible message) indicator at the parking spot or through a notification on the unauthorized user's mobile device or car. When the authorized user is detected, an indication or notification may be given that the user is authorized to park in the parking spot, such as by a green light.

In some embodiments, the service provider transmits the user ID and/or user profile information to a merchant. The merchant can then submit offers for parking spots at different locations for different prices to the service provider, who passes this information to the beacon. The beacon then transmits the offers to the user device. For example, a merchant can provide a better offer for parking spaces to users they want close to their store or they want coming to their store. The offers can include various incentives or deals (e.g., rebates, prepaid parking fees, discounts, coupons, free shipping/delivery, free gift, buy one get one free, etc.) for the user to shop at their store. The user can then choose where to park based on price and location of the parking spot, as well as any merchant provided incentives tied to the parking spot.

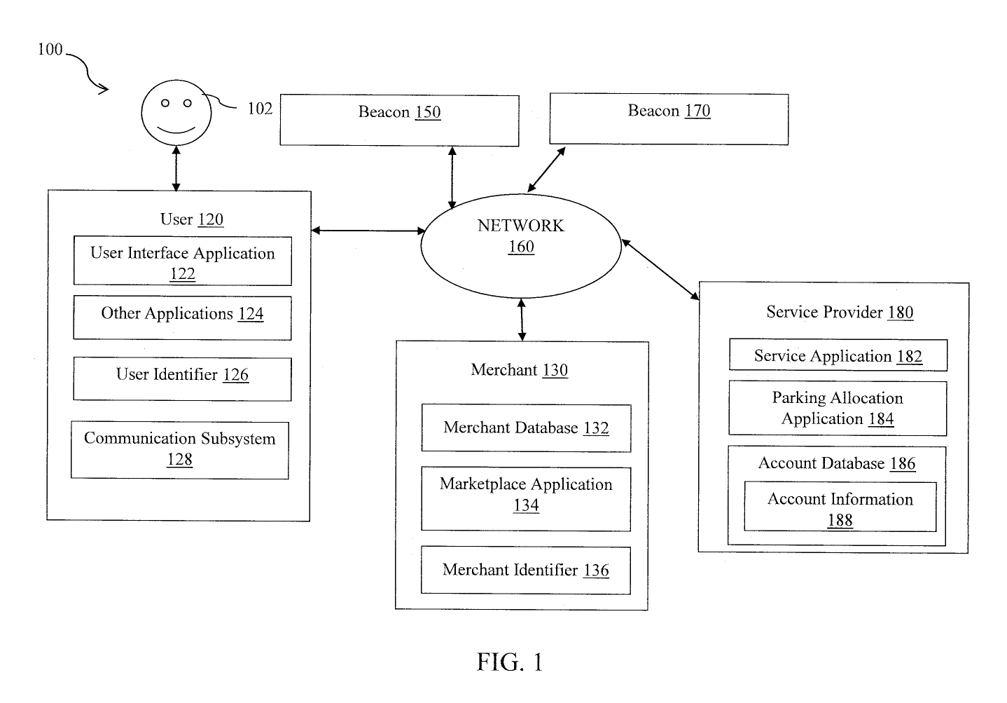

FIG. 1 shows one embodiment of a block diagram of a network-based system 100 adapted to provide parking spot information to a user, such as user 102. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a user device 120 (e.g., a smartphone), a merchant server or device 130, beacons 150 and 170 (e.g., a radio frequency beacon or Bluetooth Low Energy (BLE) beacon), and at least one service provider server or device 180 (e.g., network server device). The user device 120, merchant server 130, beacons 150 and 170, and service provider server 180 are in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. The user device 120 can communicate with the beacon 150 (and the beacon 150 can communicate with the user device 120) through BLE or other radio frequencies.

The user device 120 is configured to perform one or more tasks when user device 120 is located in proximity to the beacons 150 or 170. The task to be performed can include, for example, launching an application program, setting certain files to non-accessible mode, initiating a phone call, sounding an alarm, storing a message, displaying a message, etc.

The user device 120, in various embodiments, may be implemented using any appropriate combination of hardware and/or software configured for wired and/or wireless communication over the network 160. The user device 120, in one embodiment, may be utilized by the user 102 to interact with the service provider server 180 over the network 160. For example, the user 102 may conduct information transactions with the service provider server 180 via the user device 120. In various implementations, the user device 120 may include a wireless telephone (e.g., cellular or mobile phone), a tablet, a wearable computing device, a personal computer, a notebook computer, and/or various other generally known types of wired and/or wireless computing devices.

The user device 120, in one embodiment, includes a user interface application 122, which may be utilized by the user 102 to conduct information transactions with the service provider server 180 over the network 160. In one implementation, the user interface application 122 includes a software program, such as a graphical user interface (GUI), executable by a processor that is configured to interface and communicate with the service provider server 180 via the network 160. In another implementation, the user interface application 122 includes a browser module that provides a network interface to browse information available over the network 160. For example, the user interface application 122 may be implemented, in part, as a web browser to view information available over the network 160.

The user device 120, in various embodiments, may include other applications 124 as may be desired in one or more embodiments of the present disclosure to provide additional features available to user 102. In one example, such other applications 124 may include security applications for implementing client-side security features, calendar application, contacts application, location-based services application, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

In various implementations, a user profile may be created using data and information obtained from cell phone activity over the network 160. Cell phone activity transactions may be used by the service provider server 180 to create at least one user profile for the user 102 based on activity from the user device 120 (e.g., cell phone). The user profile may be updated with each information transaction achieved through use of the user device 120.

The user device 120, in one embodiment, may include at least one user identifier 126, which may be implemented, for example, as operating system registry entries, cookies associated with the user interface application 122, identifiers associated with hardware of the user device 120, or various other appropriate identifiers. The user identifier 126 may include one or more attributes related to the user 102, such as personal information related to the user 102 (e.g., one or more user names, passwords, photograph images, biometric IDs, addresses, phone numbers, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

In some embodiments, the user device 120 includes a communication subsystem 128, which can include radio frequency receivers and transmitters and/or optical (e.g., infrared) receivers and transmitters. The specific design and implementation of the communication subsystem 128 can depend on the communication network over which the user device 120 is intended to operate. For example, the user device 120 can include communication subsystems designed to operate over a Global System for Mobile Communication (GSM) network, a General Packet Radio Service (GPRS) network, an Enhanced Data Rates for Global Evolution (EDGE) network, a Wi-Fi or WiMax network, and a Bluetooth™ network.

The one or more merchant servers 130, in various embodiments, may be maintained by one or more business entities (or in some cases, by a partner of a business entity that processes transactions on behalf of business entities). Examples of businesses entities include merchants, resource information companies, utility companies, real estate management companies, social networking companies, etc., which offer various items for purchase and payment. In some embodiments, business entities may need registration of the user identity information as part of offering items or services to the user 102 over the network 160. As such, each of the one or more merchant servers 130 may include a merchant database 132 for identifying items for sale, which may be made available to the user device 120 for viewing and purchase by the user 102, either online or at a physical business location, and for storing a user profile (e.g., name, address, age, occupation, phone number, etc.). In various embodiments, the user profile includes the user's purchase history (e.g., items or services bought in the past, amounts spent, times the user visited the merchant, etc.).

Each of the merchant servers 130, in one embodiment, may include a marketplace application 134, which may be configured to provide information over the network 160 to the user interface application 122 of the user device 120. For example, user 102 may interact with the marketplace application 134 through the user interface application 122 over the network 160 to search and view various items or services available for purchase in the merchant database 132, including at a merchant physical location.

Each of the merchant servers 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. In various embodiments, user 102 may conduct transactions (e.g., searching, selection, monitoring, purchasing, and/or providing payment for items) with each merchant server 130 via the service provider server 180 over the network 160.

A merchant may also communicate (for example, using merchant server 130) with the service provider through service provider server 180 over network 160. For example, the merchant may communicate with the service provider in the course of various services offered by the service provider to the merchant, such as payment services between customers of the merchant and the merchant itself For example, the merchant may use an application programming interface (API) that allows it to offer sale of goods or services in which customers are allowed to make payment through the service provider, while user 102 may have an account with the service provider that allows user 102 to use the service provider for making payments to merchants that allow use of authentication, authorization, and payment services of service provider as a payment intermediary. The merchant may also have an account with the service provider.

Beacon 150 may be set up by the service provider to identify users that enter the parking structure and to transmit assigned parking spots to the users. As defined herein, a “beacon” is a short range communication device having a known or fixed location that provides a signal that can be detected by user devices within a certain proximity of the beacon. An example of a beacon is a radio frequency (RF) beacon (e.g., Bluetooth™ low energy (BLE) beacon), infrared beacon or a radio frequency identifier (RFID) tag. For example, a BLE beacon can broadcast an RF signal that includes its position coordinates (e.g., latitude, longitude), which can be detected by a user device. In some implementations, the beacon can also advertise location based services provided by a beacon network. A beacon network encompasses a plurality of beacons in a geographic region.

Beacons 150 and 170 are typically maintained by one or more service providers. When user device 120 comes in range of beacon 150 or 170, a mobile application on the user device 120 run by a service provider can wake up and connect to the beacon 150 or 170. User device 120 can then receive messages from beacon 150 or 170 and communicate with beacon 150 or 170. In some implementations, beacon 150 and/or 170 is a BLE beacon.

In certain implementations, beacon 150 is associated with a parking structure (e.g., positioned near entry points of the parking structure), receives a user ID associated with the user device 120, transmits the user ID and location of the user 120 to the merchant server 130 and/or the service provider server 180, and transmits parking space information to the user device 120. Beacon 150 can output a wireless signal that can be detected by user device 120 when user device 120 is within a certain proximity of the beacon 150. Beacon 150 may be a device that periodically or continuously transmits a signal, such as a short-distance wireless (e.g., BLE), medium distance wireless (e.g., Wi-Fi), and/or other electro, magnetic, and/or electro-magnetic transmissions. Power and/or directionality on beacon 150 can be adjusted to communicate only within a desired range and/or direction, which may depend on intended message ranges and locations. User device 120 is configured to detect the transmitted signals from beacon 150, such that when user device 120 is located within the transmission range of beacon 150, the signal may be detected.

In some implementations, in addition to beacon 150, the parking structure includes a plurality of beacons 170 that are each physically proximate to at least one parking spot. In the simplest case, each beacon 170 serves a single parking space in a one-to-one relationship. In other embodiments, several beacons 170 could serve a multiplicity of parking spots in a many-to-many relationship. In some embodiments, beacons 170 are arranged in a master-slave configuration. For example, one master beacon connected to the network 160 can be assigned to each floor of a parking structure, while several slave beacons can report information back to the master beacon.

Each parking spot may also be equipped with a sensor for determining whether a parking spot is occupied by a vehicle. In various embodiments, the parking structure includes a plurality of vehicle occupancy sensors that are each physically proximate to at least one parking spot. Occupancy of one of the parking spaces by a vehicle is sensed through the nearest vehicle occupancy sensor and the location of the parking space may be provided to the service provider server 180. The sensor can be locally connected to a nearby beacon 170, or the sensor can be incorporated into a beacon 170. Further, the sensors can be configured in a one-to-one, one-to-many, many-to-one, or many-to-many relationship with a set of parking spots.

When user 102 pulls into a parking spot, beacon 170 determines the user 102's identification from user device 120 and whether or not he or she is authorized to park in the parking spot. The beacons 170, like beacon 150, can accept wireless transmissions, for instance, using Bluetooth, Wi-Fi, or Wi-Max protocols. In some embodiments, if the user 120′s identity is not validated, beacon 170 can sound an alarm and/or alert the service provider server 180 to issue the user 102 a ticket or warning. In certain embodiments, beacon 170 can obtain and transmit a suitable parking spot from the merchant server 130 or the service provider server 180.

The service provider server 180, in one embodiment, may be maintained by a transaction processing entity, which may provide processing for information transactions for user 102. As such, the service provider server 180 includes a service application 182, which may be adapted to interact with the user device 120 over the network 160. In one example, the service provider server 180 may be provided by PayPal®, Inc. or eBay® of San Jose, Calif., USA.

The service provider server 180, in one embodiment, may be configured to maintain one or more user accounts in an account database 186 each of which may include account information 188 associated with one or more individual users (e.g., user 102). For example, account information 188 may include private information of user 102, such as one or more email addresses, passwords, account numbers, funding sources, and/or home addresses. Account information 188 may further include user 102's purchase history, such as what merchants the user 102 has visited, where the merchants are located, how much the user 102 has spent at various merchants, whether the user 102 has a loyalty card with the merchant, how often the user 102 visits various merchants, when the user 102 visits various merchants, etc. In various aspects, the methods and systems described herein may be modified to accommodate users that may or may not be associated with at least one existing user account.

In one implementation, the user 102 may have identity attributes stored with the service provider server 180, and user 102 may have credentials to authenticate or verify identity with the service provider server 180. User attributes may include personal information. In various aspects, the user attributes may be passed to the service provider server 180 as part of a login, search, and/or selection, and the user attributes may be utilized by the service provider server 180 to associate user 102 with one or more particular user accounts maintained by the service provider server 180.

In various embodiments, service provider server 180 includes a parking allocation application 184. The parking allocation application 184 receives user ID and location information from beacon 150, assigns a parking spot to the user 102 based on user ID and location, and transmits the assigned parking spot to the beacon 150, which then provides the parking spot to the user device 120. As such, the parking allocation application 184 can provide the most appropriate parking spot to a vehicle that is attempting to park.

In some embodiments, the parking allocation application 184 may receive information regarding what parking spots are available in the parking structure from sensors associated with parking spots and may communicate this information to the merchant server 130. Based on this information, the merchant server 130 can take the available parking spots and offer them to the user 102 at various prices and tied to various incentives.

In certain embodiments, the service provider server 180 may provide a map for display on the user device 120 for assisting the user 102 in locating the parking spot. In other embodiments, the service provider server 180 can provide audio instructions to the parking spot, walking distances from the parking spot to certain merchants, information regarding whether adjacent parking spots are occupied, size of the parking spot, and the like.

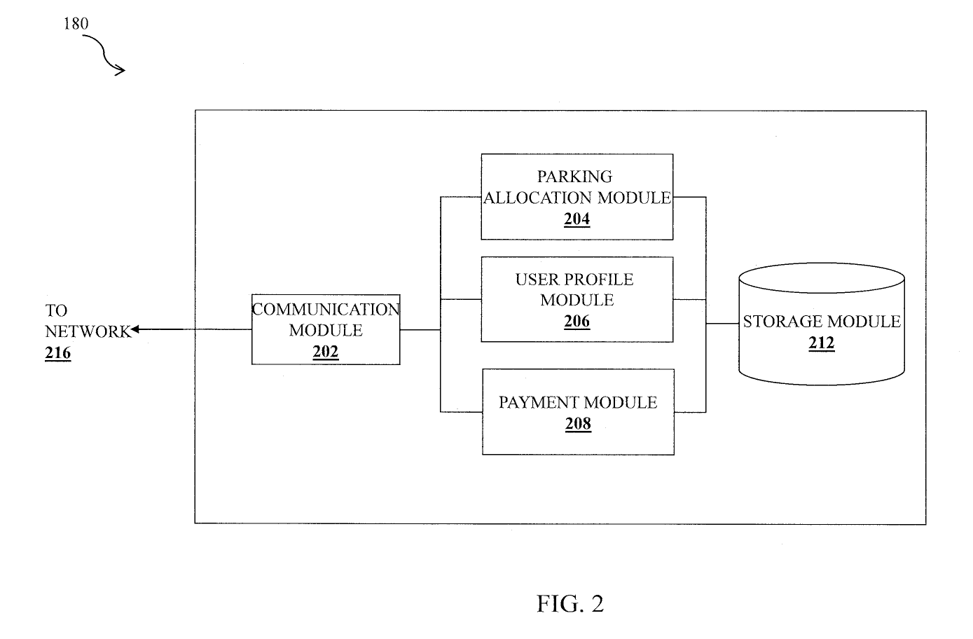

FIG. 2 illustrates an embodiment of a service provider server 180. The server 180 includes several components or modules, such as a communication module 202, parking allocation module 204, user profile module 206, payment module 208, and storage module 212.

The server 180 can include a communication module 202 that is coupled to the network 216 and to any or all of a parking allocation module 204, user profile module 206, and/or payment module 208, any of which may be coupled to a storage module 212. Any or all of the modules 202-208 may be implemented as a subsystem of the server 180 including for example, a circuit, a hardware component, a hardware subcomponent, and/or a variety of other subsystems known in the art. Furthermore, any or all of the modules 202-208 may be preconfigured to perform their disclosed functionality, or may be configured by a processing system “on-the-fly” or as needed to perform their disclosed functionality. As such, any or all of the modules 202-208 may include pre-configured and dedicated circuits and/or hardware components of the server 180, or may be circuits and/or hardware components that are configured as needed.

For example, any or all of the modules 202-208 may be provided via one or more circuits that include resistors, inductors, capacitors, voltage sources, current sources, switches, logic gates, registers, and/or a variety of other circuit elements known in the art. One or more of the circuit elements in a circuit may be configured to provide the circuit(s) that causes the modules 202-208 to perform the functions described below. As such, in some embodiments, preconfigured and dedicated circuits may be implemented to perform the functions of the modules 202-208. In other embodiments, a processing system may execute instructions on a non-transitory, computer-readable medium to configure one or more circuits as needed to perform the functions of the modules 202-208.

The communication module 202 may be included as a separate module provided in the server 180, or may be provided using instructions stored on a computer-readable medium that, when executed by a processing system in the server 180, configure the communication module 202 to send and receive information over the network 216, as well as provide any of the other functionality that is discussed herein. The communication module 202, for example, receives information from and sends information to beacons 150 and 170 and/or merchant server 130. The communication module 202 may receive user ID and location of a user from beacons 150 and/or 170and/or receive merchant parking offers from merchant server 130. The parking allocation module 204 may be included as a separate module provided in the server 180, or may be provided using instructions stored on a computer-readable medium that, when executed by a processing system in the server 180, configure the parking allocation module 204 to determine what merchants are in the vicinity or proximate to the user 102, retrieve a user profile, and assign a parking spot to user 102, as well as provide any of the other functionality that is discussed herein. In some embodiments, the parking allocation module 204 predicts arrival and departure times of user 102 from a parking spot. The parking allocation module 204 helps direct vehicles to appropriate parking spots in a parking structure to avoid congestion and frustration with finding a parking spot. The user profile module 206 may be included as a separate module provided in the server 180, or may be provided using instructions stored on a computer-readable medium that, when executed by a processing system in the server 180, configure the user profile module 206 to receive user ID and parking spot information from beacon 170, validate that the user ID matches the user ID assigned to a parking spot, and/or instruct beacon 170 to sound an alarm or otherwise alert the user 102 that he or she is not in a correct parking spot. The payment module 208 may be included as a separate module provided in the server 180, or may be provided using instructions stored on a computer-readable medium that, when executed by a processing system in the server 180, configure the payment module 208 to receive payment requests from the user 102 regarding parking spots and process the payment requests (including any incentives offered by a merchant), as well as provide any of the other functionality that is discussed herein. Furthermore, other modules discussed above but not illustrated in FIG. 2 may be provided as separate modules on the server 180, or using instructions stored on a computer-readable medium similarly as discussed above. Storage module 212 is configured to store user profile and merchant information. While the storage module 212 has been illustrated as located in the server 180, one of ordinary skill in the art will recognize that it may include multiple storage modules and may be connected to the modules 204-208 through the network 216 without departing from the scope of the present disclosure.

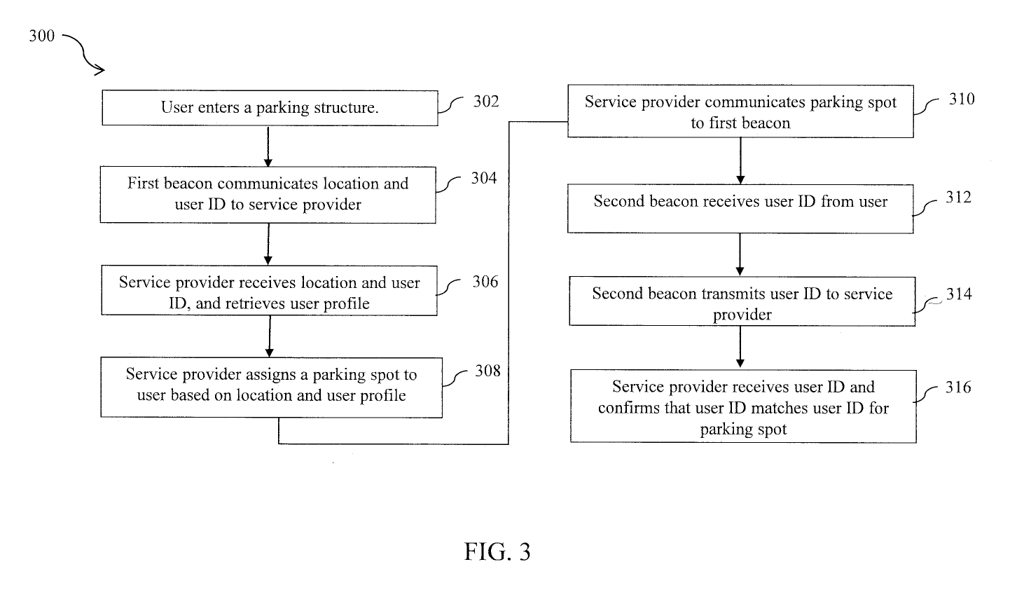

Referring now to FIG. 3, a flowchart 300 of a method for allocating a parking space to a user is illustrated according to an embodiment of the present disclosure. In various embodiments, the user 102 registers with a service provider, which runs a mobile application. Registration may include signing up for the parking allocation service and agreeing to any terms required by the service provider, such as through a user device. In one embodiment, the user device is a mobile computing device, such as a smart phone, a PC, wearable computing device, or a computing tablet. In some embodiments, registration may be done completely through the user device, partially through the user device, or without using the user device, such as through a phone call or in-person visit to a representative of the payment service provider.

The user may be requested to provider specific information for registration, such as, but not limited to, a name, address, phone number, email address, picture, a user name for the account, and a password or PIN for the account. The type of information may depend on whether the user already has an account with the service provider. Requested information may be entered through the user device or other means, including voice or manual key entry. Once all the requested information is received and confirmed, the service provider may create an account for the user.

For users not wanting or willing to participate in the parking allocation service, a different parking structure that is possibly further away from the shops and stores can be available for parking. Advantageously, signing up and participating in the parking allocation service can provide closer parking spaces and merchant incentives to the user.

At step 302, user 102 enters a parking structure or parking lot. The parking structure may be associated with a mall, shopping center, office building, business, etc. The parking structure may be a one-story or multi-story parking structure. In various embodiments, the user 102 enters a particular portion of the parking structure that provides allocated parking, which may be similar to an area designated for valet parking. Upon entering, approaching, or within the parking lot, user 102 is detected, such as by passing within communication range of one or more beacons as described herein.

At step 304, beacon 150 communicates location and user device details (e.g., user identifier 126) to communication module 202. When the user device 120 enters the vicinity of beacon 150, the user device 120 makes a connection with the beacon 150. The beacon 150 senses the user device 120 by way of electronic communication with the user device 120. As such, the specific location of user device 120 can be determined using beacon 150, which is positioned near the entrance of the parking structure (or a particular portion of the parking structure).

At step 306, the communication module 202 receives the user ID, and the parking allocation module 204 retrieves a user profile associated with the user ID. The user profile can include infoimation such as whether the user is a holder of a loyalty card or is a frequent shopper, have coupons or reward points (and whether they are expiring), what age group the user is in (e.g., student, adult, senior citizen, etc.), the occupation of the user (e.g., military, police, fire department, doctor, businessman, etc.), spending habits of the user (e.g., what the user has bought in the past and how much the user has paid for various items), specific merchants visited, expected amount of time the user will need the parking spot for (such as based on amount of time spent at various merchant stores, amount of time spent at the shopping area, time of year, etc.), specific times the user parked in a certain parking structure or location, dates and times specific merchants were visited, etc. The communication module 202 also receives the location of the user 120, and the parking allocation module 204 determines which merchants are in the vicinity of the user 102.

At step 308, the parking allocation module 204 assigns a parking spot to the user 102 based on the user's location and user profile. For example, the parking allocation module 204 determines that the user 102 is located in a shopping center that includes stores for Merchant A, Merchant B, and Merchant C. The user profile indicates that user 102 is a frequent shopper at Merchant A, has a loyalty card for Merchant A, and has coupons for Merchant A; that user 102 visits Merchant B only on weekend afternoons; and that user 102 tends to purchase several items from Merchant C when Merchant C is having a sale. In this example, the parking allocation module 204 may determine the current date/time and whether Merchant C is having a sale. Assuming it is a weekday and that Merchant C is not having a sale, the parking allocation module 204 assigns a parking spot to user 102 that is close to Merchant A. In another example, the parking allocation module 204 can estimate when user 102 is expected to arrive at a parking structure (based on previous arrival times) and assign a suitable parking spot based on expected arrival time so that a parking spot is not held open for too long. In another example, demand for parking in general and for specific spots may be factored in with estimates of how long user 102 will need the parking spot to determine an appropriate parking spot to assign user 102.

In various embodiments, the parking allocation module 204 may assign parking spots on a first-come first-served basis. The parking allocation module 204, for example, can optimize the flow of parking by sending the first five arriving vehicles to the top most floor and later arriving vehicles to lower floors to effectively route vehicles to appropriate parking spots and prevent traffic jams in the parking structure.

In several exemplary embodiments, the parking allocation module 204 turns over parking assignments to the merchant server 130. In one embodiment, once the communication module 202 receives the location of the user 102, the communication module 202 communicates user ID and/or user profile information to merchant server 130 (e.g., a merchant associated with the parking structure). For example, if the parking structure is part of a shopping center or mall, the merchant could be a store located within the shopping center or mall. Once the merchant is informed that user 102 is in a location proximate to the merchant, the merchant server 130 can review the user profile (or retrieve a user profile based on the user ID) and decide which parking spots it wants to offer, what incentives or deals are tied with each parking spot, and at what price to offer the parking spots. In an embodiment, the merchant offers the parking spots closest to their store at the lowest price to their best customers. In another embodiment, the merchant offers free parking and/or store incentives at the closest spots for their best customers.

Advantageously, the merchant is able to view where the user 102 shops (including competitor stores) and provide incentives, deals, and/or promotions to get the user 102 to visit their store and spend a certain amount of money. For example, Merchant A may offer close parking to user 102 for $5 and a $5 rebate if user 102 spends at least $50 at Merchant A. Merchant B can offer a farther parking spot for $2 and a free gift, free delivery, and/or coupons for use at Merchant B. Merchant C can offer a spot closer to Merchant B, but will pay user 102 $10 for parking and going into Merchant C and spending at least $20. User 102 can then select a parking spot based on location, price, and any incentives tied to the parking spot. In another embodiment, the merchant knows that the user 102 has been in the parking structure many times before and that user 102 is an employee of the merchant so the merchant offers a suitable parking spot at a lower price.

In some embodiments, merchants may want to encourage regular customers or customers with a history of spending large amounts of money to come to their store as part of a sale or other promotional event. In this case, the merchant can offer these customers parking spots closest to their store, and parking fees can be prepaid by the merchant.

In certain embodiments, the communication module 202 receives merchant parking spot offers even before the user 102 is detected in the parking structure. In these embodiments, the storage module 212 stores the offers, and the parking allocation module 204 retrieves the stored offers from the storage module 212, and matches the offers with the user profile to determine what offers to present to the user 102.

At step 310, the communication module 202 communicates the assigned parking spot or merchant parking spot offers to the beacon 150, which transmits this information to user device 120. The user 102 can then drive to the assigned parking spot or select one of the merchant parking spot offers through the user device 120. If the user 102 selects a merchant parking spot offer, the selection is transmitted to and received by the communication module 202.

At step 312, the beacon 170, which is associated with the assigned or selected parking spot, receives the user ID from user device 120. When the user 102 pulls into the assigned or selected parking spot, the user device 120 can communicate with the beacon 170.

At step 314, beacon 170 transmits the user ID and parking spot information (e.g., parking spot number) to communication module 202. At step 316, the communication module 202 receives the user ID, and user profile module 206 confirms or validates that the user ID matches the user ID assigned to the parking spot. If the user IDs do not match, user profile module 206 can instruct beacon 170 to sound an alarm, flash red lights, and/or alert service provider server 180, who can give the user 102 a parking ticket or warning. On the other hand, if the user 102 is detected by beacon 170 as being authorized to park at the parking spot (e.g., user or device ID matches what had previously been assigned to the spot), a notification may be given to indicate that the user 102 is authorized to park there, such as a green light, a notification on the user mobile device or car, or an audio notification (such as “Merchant C welcomes Mr. Jones”). Notification that user 102 has parked at the assigned parking spot can then be communicated to appropriate recipients, such as Merchant C, as desired. For example, Merchant C can then provide user 102 with any incentives previously offered or new incentives or messages,

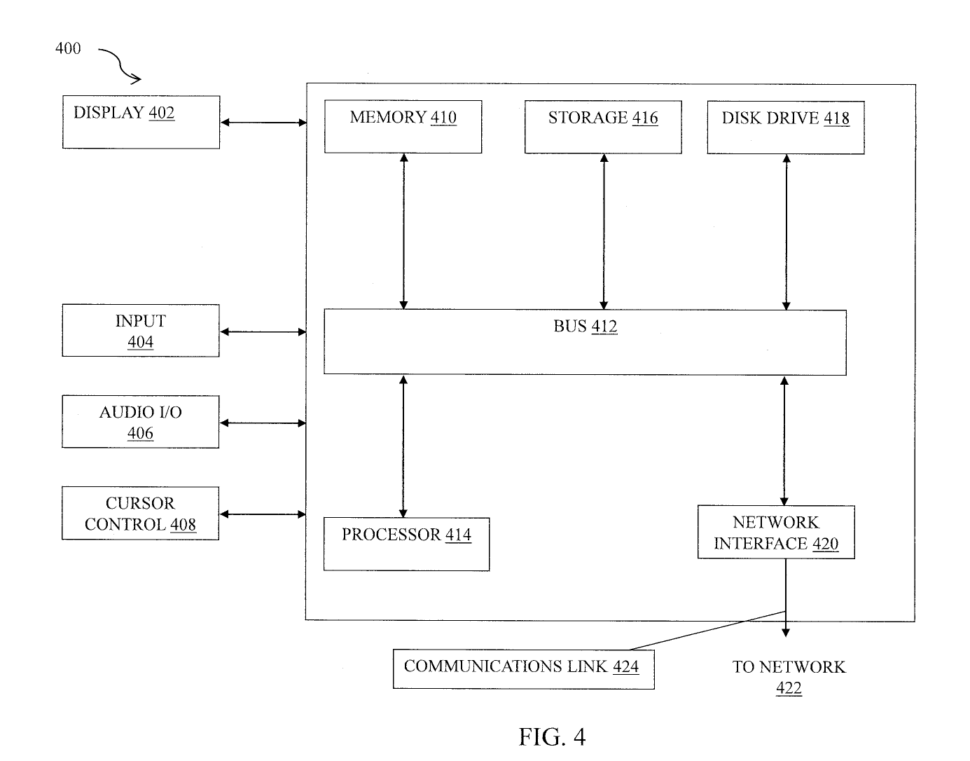

FIG. 4 is a block diagram of a computer system 400 suitable for implementing one or more embodiments of the present disclosure, including the user device 120, the merchant server 130, beacon 150, beacon 170, and the service provider server 180. In various implementations, the user device 120 may comprise a mobile cellular phone, personal computer (PC), laptop, wearable computing device, etc. adapted for wireless communication, and the merchant server 130, and/or service provider server 180 may comprise a network computing device, such as a server. Thus, it should be appreciated that the devices 120, 130, 150, 170, and 180 may be implemented as computer system 400 in a manner as follows.

Computer system 400 includes a bus 412 or other communication mechanism for communicating information data, signals, and information between various components of computer system 400. Components include an input/output (I/O) component 404 that processes a user (i.e., user 102, merchant, service provider) action, such as selecting keys from a keypad/keyboard, selecting one or more buttons or links, etc., and sends a corresponding signal to bus 412. I/O component 404 may also include an output component, such as a display 402 and a cursor control 408 (such as a keyboard, keypad, mouse, etc.). An optional audio input/output component 406 may also be included to allow a user to use voice for inputting information by converting audio signals. Audio I/O component 406 may allow the user to hear audio. A transceiver or network interface 420 transmits and receives signals between computer system 420 and other devices, such as another user device, a merchant server, or a service provider server via network 422. In one embodiment, the transmission is wireless, although other transmission mediums and methods may also be suitable. A processor 414, which can be a micro-controller, digital signal processor (DSP), or other processing component, processes these various signals, such as for display on computer system 400 or transmission to other devices via a communication link 424. Processor 414 may also control transmission of information, such as cookies or IP addresses, to other devices.

Components of computer system 400 also include a system memory component 410 (e.g., RAM), a static storage component 416 (e.g., ROM), and/or a disk drive 418. Computer system 400 performs specific operations by processor 414 and other components by executing one or more sequences of instructions contained in system memory component 410. For example, processor 414 can receive user ID and location of a user from a beacon, determine merchants in the vicinity of a user, retrieve user profiles, assign parking spots, and transmit parking spots and/or merchant parking spot offers. Logic may be encoded in a computer readable medium, which may refer to any medium that participates in providing instructions to processor 414 for execution. Such a medium may take many forms, including but not limited to, non-volatile media, volatile media, and transmission media. In various implementations, non-volatile media includes optical or magnetic disks, volatile media includes dynamic memory, such as system memory component 410, and transmission media includes coaxial cables, copper wire, and fiber optics, including wires that comprise bus 412. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 424 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a storage module that stores user profile information;
a communication module that receives user identification and location of a user from a first beacon associated with a parking structure, and transmits at least one parking spot or parking spot offer to the first beacon; and
a parking allocation module that retrieves a user profile based on the user identification and causes at least one parking spot or parking spot offer to be provided to the user based on the user profile and location of the user.

2. The system of claim 1, wherein the user profile comprises one or more of whether the user is a holder of a loyalty card or is a frequent shopper at a particular merchant, has coupons or reward points, what age group the user is in, occupation of the user, spending habits of the user, particular merchants visited by the user, expected amount of time the user will need the parking spot for, amount of time spent at particular merchants, and specific times the user parked in particular parking structures.

3. The system of claim 1, wherein the parking allocation module further predicts an arrival time of the user based on the user profile, the communication module further receives available parking spot information, or both.

4. The system of claim 1, wherein the parking allocation module causes the at least one parking spot or parking spot offer to be provided the user by assigning a parking spot to the user.

5. The system of claim 1, wherein the parking allocation module causes the at least one parking spot or parking spot offer to be provided to the user by transmitting the user identification, user profile, or both to one or more merchants that are proximate to the location of the user.

6. The system of claim 5, wherein the communication module further receives at least one parking spot offer from the one or more merchants.

7. The system of claim 6, wherein the parking spot offer comprises a parking spot, price for the parking spot, incentive to park in the parking spot, or any combination thereof.

8. The system of claim 7, wherein the incentive comprises one or more of a rebate, paid parking fee, discount, coupon, free gift, free delivery, or any combination thereof.

9. The system of claim 1, wherein the communication module further receives user identification and a parking spot where the user has parked from a second beacon.

10. The system of claim 9, wherein the second beacon is proximate to the parking spot where the user has parked.

11. The system of claim 10, further comprising a user profile module that validates that the user identification received from the second beacon matches the user identification of a user assigned the parking spot where the user has parked.

12. The system of claim 11, wherein the user profile module further instructs the second beacon to notify the user that the user is not authorized to park in the parking spot where the user has parked when the user identifications do not match.

13. A method for allocating a parking spot to a user, comprising:
receiving, by a communication module of a service provider, from a first beacon associated with a parking structure, user identification and location of a user from a user device;
determining, by a parking allocation module of the service provider, one or more merchants in a vicinity of the user based on the received location;
retrieving, by the parking allocation module, a user profile associated with the user identification;
assigning, by the parking allocation module, a parking spot to the user based on the determined one or more merchants and the user profile; and
transmitting, by the communication module to the first beacon, the assigned parking spot.

14. The method of claim 13, wherein the user profile comprises one or more of whether the user is a holder of a loyalty card or is a frequent shopper at a particular merchant, has coupons or reward points, what age group the user is in, occupation of the user, spending habits of the user, particular merchants visited by the user, expected amount of time the user will need the parking spot for, amount of time spent at particular merchants, and specific times the user parked in particular parking structures.

15. The method of claim 13, further comprising receiving, by the communication module, available parking spot information, and assigning, by the parking allocation module, the parking spot based on the available parking spot information.

16. The method of claim 13, further comprising receiving, by a user profile module, user identification and a parking spot where the user has parked from a second beacon, and validating, by the user profile module, that the user identification received from the second beacon matches the user identification of a user assigned the parking spot where the user has parked.

17. A non-transitory computer-readable medium comprising executable modules which, in response to execution by a computer system, cause the computer system to perform a method comprising:
receiving, by a communication module from a first beacon positioned at an entry point of a parking structure, user identification and location of a user;
retrieving, by a parking allocation module, a user profile associated with the user identification;
transmitting, by the communication module to a merchant proximate to the user, the user identification, user profile, or both;
receiving, by the communication module from the merchant, a parking spot offer comprising a parking spot, a price for the parking spot, and an incentive for the parking spot; and
transmitting, by the communication module to the first beacon, the parking spot offer.

18. The non-transitory machine-readable medium of claim 17, wherein the communication module receives the parking spot offer before the communication module receives the user identification and location of the user.

19. The non-transitory machine-readable medium of claim 18, wherein the method further comprises storing, by a storage module, the parking spot offer.

20. The non-transitory machine-readable medium of claim 19, wherein the method further comprises determining, by the parking allocation module, whether to present the parking spot offer based on the user profile.
